(19) United States
(12) Patent Application Publication
(10) Pub. No.: US 2022/0198466 A1
(43) Pub. Date: Jun. 23, 2022

(54) DEADLINE MANAGEMENT SERVER, AGENT PROGRAM, AND TERMINAL RENTAL SYSTEM

(71) Applicant: CO-CONV, Corp., Kyoto (JP)

(72) Inventor: Shin Maruyama, Toyonaka-Shi (JP)

(73) Assignee: CO-CONV, Corp., Kyoto (JP)

(21) Appl. No.: 17/604,208

(22) PCT Filed: Apr. 10, 2020
(86) PCT No.: PCT/JP2020/016092

§ 371 Date: Oct. 15, 2021

(30) Foreign Application Priority Data
Apr. 16, 2019 (JP) 2019-078129

(51) Int. Cl. G06Q 30/00; G06Q 30/06; G06F 21/34

(52) U.S. Cl. CPC G06Q 30/018; G06F 2221/2137; G06F 21/34; G06Q 30/0645

(57) ABSTRACT

There is provided, in relation to a terminal lending system, a system that is capable of setting a terminal in a usable state only during a period that is set in advance. A deadline management server for managing a return deadline for a terminal for lending, where, in response to a request for terminal activation issued to the deadline management server by an agent program executed on the terminal, the deadline management server issues activation period data including deadline data regarding the return deadline for the terminal, the deadline data being set in advance by the deadline management server, and causes the agent program to change setting of the terminal.

### CROSS-REFERENCE TO RELATED APPLICATIONS

This application is a U.S. national phase entry of and claims priority to PCT International Phase Application No. PCT/JP2020/016092, filed Apr. 10, 2020, which claims priority to Japanese Patent Application No. 2019-078129, filed Apr. 16, 2019. The entire contents of the above-referenced applications and of all priority documents referenced in the Application Data Sheet filed herewith are hereby incorporated by reference for all purposes.

### TECHNICAL FIELD

The present invention relates to a deadline management server, an agent program, and a terminal rental system.

### BACKGROUND ART

Various systems for collectively managing a large number of computers, such as network boot and disk download, are known (Patent Literatures 1, 2 and the like). These are each already put to practical use as a terminal management server for updating and maintaining an operating system (OS) and security software of a computer in the latest state at all times.

A terminal management server is an apparatus that was initially developed to efficiently manage a large number of computers (client terminals) installed in a school, an office or the like, and the client terminals had to be connected to a wired LAN. Accordingly, the client terminals were inevitably fixedly installed. It is considered that, if a management mechanism of such a terminal management server is applied to “a computer that includes a battery inside and that can easily be carried” (hereinafter referred to as “terminal” in the present specification), such as a laptop personal computer or a tablet, a large number of terminals can be appropriately managed. These terminals are expected to be usable by being connected to a wireless LAN, and thus, a use mode of the terminals inevitably changes from one in which the terminals are fixedly installed to one in which the terminals are lent by some kind of method and carried out. Moreover, business of rental the terminals to a large number of users for a certain period of time at a cost or free of charge and asking the users to return the terminals by respective deadlines can be realized.

For business of rental some kind of movable asset in the above manner, it is necessary to record which movable asset is lent to whom, and to manage the return deadline for each movable asset. Furthermore, how to cope with events such as delay and loss has to be considered in advance. For example, in the case of business of rental movable assets (such as bicycles or cars, Wi-Fi routers, clothing/tools, media such as CDs and DVDs, and the like), there is generally an agreement to terms and conditions according to which an overdue fee is to be paid or collected from a deposit made at the time of rental, at the time of return. In the case of books lent by general public libraries, there is normally no fee for rental, and in the case of overdue return, penalties may be imposed for the overdue return in the form of restrictions on the next rental, such as by “reducing the next rental period” or “prohibiting rental for a certain period of time”.

Furthermore, in the business of rental movable assets as described above, the movable assets are normally prepared in a number sufficient for an expected number of users. This allows a certain margin for coping with an event such as an overdue return, and also, it is more general to secure a time for maintenance of a returned object in preparation for the next rental by preventing one movable asset from being lent continuously to a plurality of users.

### CITATION LIST

### Patent Literature

Patent Literature 1: Japanese Patent No. 6072352

Patent Literature 2: Japanese Patent No. 4808275

### SUMMARY OF INVENTION

### Technical Problem

An object of the present invention is to solve various problems that may arise when existing business of rental movable assets is applied to a terminal, that is, when a “terminal rental system” is provided.

In relation to terminals for rental, as in the case of business of rental other types of movable assets, one object for rental is successively used by a plurality of users, but generally, terminals are expensive and it is difficult to prepare a sufficient number for all the users who need the terminal. Accordingly, operation has to be performed by strictly setting the return deadline, and smooth operation is based on a premise that the user keeps to the return deadline. However, in reality, overdue returns happen. Penalties such as “reduction in the next rental period” and “prohibition of rental for a certain period of time” as in the case of existing business of rental movable assets are known to have an adverse effect when applied to cope with problems caused by overdue returns in the above case. This is because, due to the number of terminals being smaller than the number of users, one is led to think “I should not return the terminal until I have finished using it, because I may not be able to borrow it once I return it”.

Considering the fact that the target object for rental is a “terminal”, it is technically possible to predict an arrival of a return deadline and to cause a display urging return to be displayed on a screen of the terminal, or to force logout with arrival of the return deadline as a trigger, when a system administrator (an owner side) performs setting in advance such that a predetermined program is booted according to a schedule. However, all the terminals for rental are generally set in a same state regardless of the user, by using a mechanism such as a terminal management server, and uniform setting such as “usable for only two hours after power is turned on” is easily implemented, but services cannot be provided attentively in the manner of “set a different use deadline for each user”, “change the return deadline during rental”, and “change user during rental”.

Furthermore, a problem different from that in the case of rental bicycles and DVDs may arise due to the target object for rental being a “terminal”. Data created by a previous user and use history often remain in a terminal, and it is not desirable to lend the terminal successively to a plurality of users, from the standpoint of information leakage and privacy. Particularly, if, due to a method such as automatic logon, the terminal is usable by everyone just by turning on the power, without logon authentication, anyone can use the terminal that is being lent to someone else with no authentication, and such a situation is inappropriate from the standpoint of security. Accordingly, before renting the returned terminal to the next user, data and the like created by the previous user have to be made invisible to the next user by some means.

To this end, a method is conceivable according to which only one account is created for one terminal to be shared by everyone and automatic logon is performed by the account, and according to which setting is performed such that contents of a disk are returned to an initial state where power of the terminal is switched off or the lid of a laptop personal computer is closed. However, if the terminal is returned without being shut down, there is a risk of information leakage. Furthermore, a setting according to which user data is erased just by the user rebooting the terminal by mistake during use is inconvenient for the user using the terminal. Moreover, even if such setting and operation are possible, rebooting is necessary before renting to the next user. If rebooting is always necessary between return and the next rental, in the case of a situation where a large number of terminals are to be lent to a large number of users, smooth rental cannot be performed because time is necessary between return and the next rental.

As another method, it is also conceivable to perform authentication at the start of use of the terminal by using a user name and a password, and to use a mechanism in an operating system of the terminal to separate environment on a per-user basis. That is, a method is conceivable according to which the terminal is used by an account that is different for each user, and the environment is separated on a per-account basis such that data created under a different account cannot be seen. However, the policy of creating the account in each terminal to be lent to a respective user makes operation and management extremely burdensome and complex.

Accordingly, a policy of configuring a server for account management and of performing authentication and separation of environment by using the server through a network may also be considered. Furthermore, Windows 10 of Microsoft Corporation includes a mechanism called Active Directory, and the environment may be separated on a per-user basis by a method of inputting a user name and a password at the time of using a terminal, for example. In this case, because the user name and the password are stored in an Active Directory server, the user account does not have to be created for each terminal. However, a mechanism of managing accounts in a centralized manner by such a server is based on a premise that the terminal and the server are connected to each other online at all times. With a terminal rental system where it is not possible to predict the environment where a terminal that is lent to a user is to be used, the terminal is of course expected to be used also offline (in a state of not being connected to the server or the like), and a method of performing management by the server in a centralized manner as described above cannot be adopted.

Similarly, also with respect to management of the return deadline for each user, a method is conceivable according to which a “deadline management server” for managing deadlines is installed, and communication with the server is performed on a regular basis during use by a user to inquire as to whether use can be continued or not, but this method cannot be adopted in an environment where offline use is expected.

In this way, a solution that is easily conceivable with respect to a certain problem includes many contradictions such as creation of other problems.

The present invention has been made in view of the above, and a main technical aim thereof is to provide a new mechanism for simultaneously achieving, by a system for renting a terminal, “swift renting process”, “separation of environment on a per-user basis” and “management mechanism according to which a terminal can be used only in a period that is set in advance” while allowing use in an offline environment as a matter of course.

### Solution to Problem

A deadline management server according to the present invention is a deadline management server for managing a return deadline for a terminal for rental, wherein

in response to a request for terminal activation issued to the deadline management server by an agent program executed on the terminal, the deadline management server

issues activation period data including deadline data regarding the return deadline for the terminal, the deadline data being set in advance by the deadline management server, and

causes the agent program to change setting of the terminal.

The “terminal activation” is an operation that is performed on the terminal that is lent, in order to set the return deadline for the terminal at the time of initial use of the terminal by a user who is to use the terminal or to change the return deadline set in advance for the terminal in a case where the terminal is already being used.

The request for terminal activation is issued by the agent program that is executed on the terminal. The request preferably but not necessarily includes unique terminal information for identifying the terminal. The unique terminal information is information that enables identification of the terminal, and may be a host name, an IP address, a MAC address, or a serial number, for example. However, in the case where a terminal locker or the like described in an example below is used, which user borrowed which terminal can be checked, and thus, in the case where the user can be identified by using a personal device of the user, such as a smartphone, the unique terminal information does not necessarily have to be included in the request for terminal activation. In this case, the request for terminal activation issued by the agent program may mean urging the user to perform authentication by using the personal device. That is, because the terminal for renting is lent by identifying the user in advance, if the deadline management server can acquire the unique terminal information by some kind of method and a correspondence relationship with the user can be confirmed, the user who uses the terminal during a rental period of the terminal may be estimated to be a receiving person of rental.

The agent program receives the activation period data issued by the server by some kind of method and executes “activation of the terminal”, and thus sets the terminal in a usable state until the return deadline included in the activation period data. That is, to “change setting of the terminal” includes setting or change of a use deadline for the terminal. To “change the return deadline” typically means extending the return deadline in the case where the return deadline is to be extended, but may include, in rare cases, reducing the return deadline or changing a start date/time of rental.

Alternatively, an indefinite return deadline may be set with the condition of payment of an adequate price for the terminal, for example, so as to obtain a substantially same effect as purchase.

In short, to perform terminal activation, at least the followings are necessary: (1) identification of the terminal (by some kind of method), and (2) setting of the return deadline for the terminal. This at least enables a period during which a terminal can be used (the return deadline) to be set on a per-terminal basis when a user is to use the terminal.

In the configuration described above, after issuing the activation period data, the deadline management server may transmit the activation period data for being received by the agent program, through a network (or a recording medium).

In the case where the deadline management server and the terminal for renting are directly connected through a network, the request for terminal activation may be directly transmitted to the deadline management server through the network, and the terminal activation period data may be directly transmitted to the terminal through the network. As the network in this case, a network where communication is performed by a TCP/IP protocol is assumed, and both the Internet and a local area network are included, but a network where communication is performed by other protocols may also be included.

Additionally, in a case where the network cannot be used, terminal activation may be performed even in a state where the terminal is not connected to the network, as long as the deadline management server can receive the “request for terminal activation” from the terminal and the terminal can receive the “activation period data” from the deadline management server, via a recording medium or the like.

In the configuration described above, after issuing the activation period data, the deadline management server may issue and transmit a code indicating information indicating the activation period data or information associated with the activation period data, which is indirect transmission to the agent program through the code.

As described above, as the method adopted by the agent program to receive the “activation period data” from the deadline management server, a method of indirect reception through a code or the like is conceivable, in addition to a case of the terminal receiving the activation period data itself directly through a network or a recording medium such as an USB memory. The “code” here is assumed to be “coded data” such as a two-dimensional code exemplified by a QR code (registered trademark), a character string or the like, for example. In the case of indicating the activation period data itself, the coded activation period data may hold, as they are, information regarding a use period included in the “activation period data”, notification data indicating success/failure of user authentication and other pieces of necessary information (because, in the case of a general two-dimensional code, information of about 2000 bits may be embedded, for example; additionally, here, the code may be a recording medium).

Moreover, for “indirect transmission to the agent program through the code”, a method is conceivable according to which the code (image data or the like) is transmitted to the personal device of the user, such as a smartphone, by means of an email or a text message and the code is displayed on the personal device of the user, and the agent program receives the activation period data by reading the code by an input device, such as a camera or the like, provided at the terminal that is to perform terminal activation, for example.

Additionally, the code is not limited to a two-dimensional code, and may instead be a character string or the like. According to such a method, the code may be indirectly received through the personal device that is connected to the network, and thus, terminal activation may be indirectly performed through the code received by the personal device even if the terminal that is to perform terminal activation and the deadline management server are not directly connected through the network. Furthermore, the coded activation period data may be encrypted. Additionally, there is a case where the code is not the activation period data itself but is address data for accessing the activation period data (such as URL link information). In this case, the terminal that is to perform terminal activation has to be connected to the network or the like to receive the activation permission data.

In the configuration described above, a user authentication server may receive user authentication data input to the terminal through the agent program and determine failure/success of user authentication, and

in the case of success of user authentication, the deadline management server may notify the terminal of success/failure of the user authentication by including notification data indicating user authentication success in the activation period data based on a result of the determination.

In the case where user authentication is to be performed through the agent program at the time of terminal activation, a method of separately preparing an authentication server that provides an authentication database and of performing user authentication with the agent program is conceivable. To determine success/failure of user authentication, a user name and a password for each user may be held in the authentication server in advance to be checked against the user authentication data input by the user. Additionally, the deadline management server may also serve the role of the authentication server.

Furthermore, the deadline management server may be configured such that,

in a case where the terminal for renting and a user are associated with each other at a time of rental of the terminal, by a terminal locker recording a rental record of the terminal, and the unique terminal information is included in the request for the deadline management server,

whether user information included in user authentication data matches the user renting the terminal may be checked by checking the unique terminal information included in the request against the renting record at a time of rental of the terminal.

In the configuration described above, the authentication server may include a mechanism for authenticating a user who uses the terminal, through a personal device of the user, and

may determine success/failure of the user authentication when the request for terminal activation of the terminal is notified to the authentication server through the personal device of the user,

the activation period data may further include notification data indicating a result indicating success of the user authentication, and

a configuration for coding and transmitting the activation period data to the personal device may be included.

As the mechanism for authenticating the user based on the personal device of the user, a mechanism is conceivable according to which information is transmitted by the authentication server to an email address or an account for a messaging tool registered in advance in association with the user, and authentication of the user is performed based on whether the information is appropriately received. Furthermore, as another mechanism, a mechanism may be used according to which a code including the unique terminal information and an URL of the authentication server, displayed on a screen of the terminal by the agent program, is read through the personal device, and authentication of the user is performed by causing a user name and a password to be input at a destination indicated by the URL of the authentication server. Additionally, the function of the authentication server may be implemented by the deadline management server.

An agent program according to the present invention is an agent program to be executed on a terminal for renting, wherein

at a time of initial use of the terminal by a user who is to use the terminal or at a time of the user using the terminal beyond a return deadline set in advance for the terminal,

the agent program directly or indirectly receives activation period data including at least deadline data regarding the return deadline for the terminal set in advance by a deadline management server, and changes setting information of the terminal according to the deadline data included in the activation period data.

Here, specifically, to “change setting information of the terminal” includes a case of allowing a user to use the terminal for a predetermined period of time by performing setting for allowing logon to the terminal by creating an account to be used by an operating system of the terminal or by changing a password, for example, and specifically, includes creation of an account to be used by the operating system of the terminal according to authentication information input to the terminal by the user through the agent program or authentication information included in the activation period data.

Additionally, as described above, the agent program may read the activation period data that is coded, from a personal device of a user through an input device of the terminal. As a method of transferring the coded activation period data at this time, a method of displaying a QR code (registered trademark), a barcode or the like on a screen of the personal device and using a device such as a camera or a barcode reader as the input device of the terminal, or a method of using short-range communication according to Bluetooth (registered trademark) may be assumed, for example.

Furthermore, in a case where notification data indicating a result indicating success of user authentication is included in the activation period data, the agent program may change the setting information of the terminal according to authentication information input through the agent program or authentication information included in the activation period data.

Specifically, a method is conceivable according to which the agent program receives terminal authentication information including a set of user ID and password to be used by the user to log onto the borrowed terminal, and creates a user account in the terminal.

Furthermore, as another method, a method of setting a logon account (a common user ID and a provisional password) in advance for the terminal, and changing only the “password” on a per-user basis is conceivable. In this case, an account is created in the terminal in advance, and the activation period data is received from the deadline management server using a personal device of the user, such as a smartphone, and also, a one-time password is generated from random numbers, and the received activation period data is coded together with the password into a code such as a QR code (registered trademark) and transferred to the agent program operating on the terminal to thereby change the provisional password for the account created in advance in the terminal, and the password after change is displayed on the screen of the personal device to thereby allow the user to log on. In this case, whether the device may be activated in relation to the user is determined by activating an application on the personal device and based on information about the smartphone (such as a telephone number), and the role of the deadline management server is only to issue the activation period data including the deadline data regarding the return deadline for the terminal, and terminal authentication is performed in a simplified manner by the personal terminal that is an external device.

Here, causing the users to use different user IDs when they use the terminal increases security, and also achieves an effect of reducing a work time until the terminal is lent to the next user after being returned. That is, by focusing on the fact that a laptop personal computer is generally returned with the lid closed, and by causing the terminal to be locked when the lid is closed (that is, by making logon necessary at the time of next use), information created by a previous user can be prevented from being easily seen by other users. Furthermore, even if the terminal that is returned with the lid closed is immediately lent to the next user, this user logs on with a different user ID and cannot see the information that is created by the previous user.

In the configuration described above, the agent program may include issuing an alarm to urge the user to perform return, before the return deadline for the terminal. As the alarm, the return deadline may be displayed on the screen in an easily visible manner when a date/time that is set advance (such as six hours before the return deadline, for example) is reached, or sound or voice may be used as an alarm. The terminal may be in an offline state at the time of issuance of the alarm.

In the case where activation of the terminal is performed through the personal device of the user, the deadline management server may issue the alarm for urging return to the personal device.

Also in this case, the terminal may be in an offline state. That is, the user may be notified of arrival of the deadline and be urged to perform return even in a case where the terminal is offline or the power is off.

That is, the deadline management server may hold information about the personal device used for processing of the terminal activation at least until the terminal is returned, and may issue an alarm to the personal device when the return deadline approaches.

If, at the end of the return deadline, there is a margin in relation to rental state of terminals, there is an option to extend the return deadline. An extension process may be performed by the agent program, but it is also possible to update the setting information of the terminal by receiving the extended activation period data through the personal device.

Furthermore, when the deadline for return is missed, the agent may make the terminal substantially unusable by forcing the user to log off or by preventing logon from being performed again by changing setting of the terminal.

Furthermore, repeatedly notifying the personal device used for activation processing of expiry of the return deadline by the deadline management server is also considered effective for urging swift return.

A value created based on unique terminal information for identifying the terminal may be used as a key at a time of encrypting the notification data indicating user authentication success.

The terminal rental system according to the present invention is a terminal rental system including any one of the deadline management servers described above and a terminal for renting where any one of the agent programs described above is executed. An unconventional, novel and effective terminal rental system may thereby be structured.

### BRIEF DESCRIPTION OF DRAWINGS

FIG. 1 is an example overall configuration of an embodiment.

FIG. 2 is an example of operation steps of a deadline management server of the embodiment.

FIG. 3 is an example of operation steps of an agent program of the embodiment.

FIG. 4(A) is an example of a dialog screen activated by the agent program, and FIG. 4(B) is a screen after successful activation.

### DESCRIPTION OF EMBODIMENTS

### (First Embodiment)—Basic Idea—

When first using a terminal, a user does not really get a strange feeling even if somewhat special procedures are needed. Accordingly, activation (registration for use) is designed to be necessary immediately after the terminal is lent. That is, there is no difference to the fact that “a terminal for renting is expected to be used offline (in a state where there is no network connection)”, but an operational restriction that “a terminal has to be used in a place where there is a network connection at the time of initial activation immediately after the terminal is lent” is imposed. This restriction is not a big obstacle to use of a terminal for renting if care is taken to prepare a wireless LAN environment in a space for renting of the terminal, for example. At the time of activation, the user of the terminal is authenticated, and also, setting information set in relation to the user is acquired from a deadline management server, and restrictions and settings are implemented in the terminal on a per-user basis. As a result, use of the terminal may be started in a state where the terminal is customized for each user. Additionally, a method of replacing the restriction by another restriction will be described in a second embodiment.

### —Example Overall Configuration—

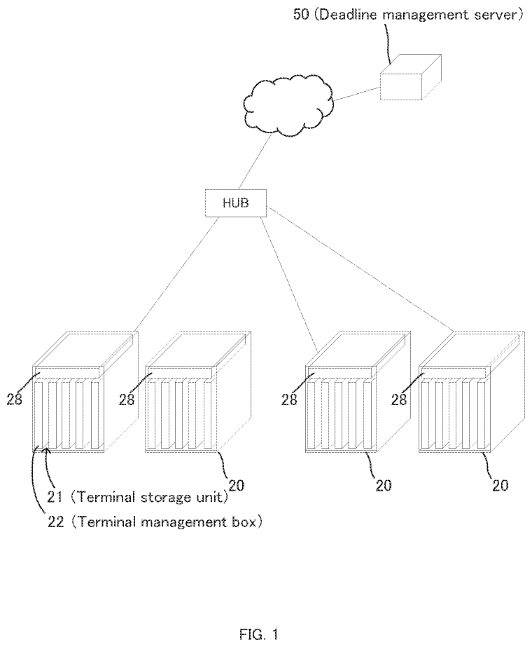

FIG. 1 is a diagram for describing an overall configuration of the present invention. A plurality of terminals are stored in a terminal accommodation unit (hereinafter referred to as “locker 20”). There may be one or more lockers 20. A server for managing a return deadline (hereinafter referred to as “deadline management server 50”) is connected to each terminal through a network. Additionally, in the configuration of the present embodiment, the locker (or more strictly, a “lock” mechanism for preventing smuggling out by an unauthorized person) is not essential. In the case where renting the terminal is managed by a person, as in the case of books for renting in a library, an identification code label may be attached to the terminal and the terminal may be stored in an appropriate storage space such as a bookshelf. In the case of an unmanned management using the locker 20, a terminal locker control unit 28 is provided, one for each locker 20, and terminal storage units 21 and terminal management boxes 22 are provided in the same number as the number of terminals, and moreover, a system as a whole may include a power supply control server for controlling a state of power supply to each terminal by communicating with the terminal management box 22, and a terminal management server for distributing a disk image of an operating system and update data to each terminal, but these are not essential.

Furthermore, in the case where a server for providing other functions (such as a reservation management server for managing a stock of the terminals or rental reservation information, for example) is to be provided, the deadline management server 50 may also serve the role of such a server. The reservation management server is a server for holding, at the time of reservation for renting, information indicating who is renting which terminal (or a terminal from which locker) from when to when, and for managing a stock of terminals available for renting, and thus, many of pieces of information to be held are information needed by the deadline management server, and it is considered that there is good compatibility between the two. Alternatively, a configuration may be adopted where separate servers are configured, and where only necessary information is shared. For its parts, each terminal includes an agent program installed therein, the agent program including a function of managing a return deadline, a function of performing activation on a logon screen, a function of extending the return deadline, a function of notifying the user that the return deadline is close, and the like.

The deadline management server 50 serves the role of grasping a rental state of terminals, and of issuing a notification regarding information about the return deadline to a terminal (an agent program) that is being lent when a user performs activation of the terminal. Furthermore, a request for extension of the return deadline and change of the user (registration of a new user) may also be handled.

The deadline management server 50 may be configured to include a function of urging return in the case where the return deadline approaches without the terminal being returned, by transmitting a text message to a mobile phone or a message to an email address, the mobile phone and the email address being registered in advance by the user. An authentication function for authenticating ID/PW input at the time of the user logging onto the terminal may also be included, but the authentication function does not necessarily have to be provided in the deadline management server.

### -Example-

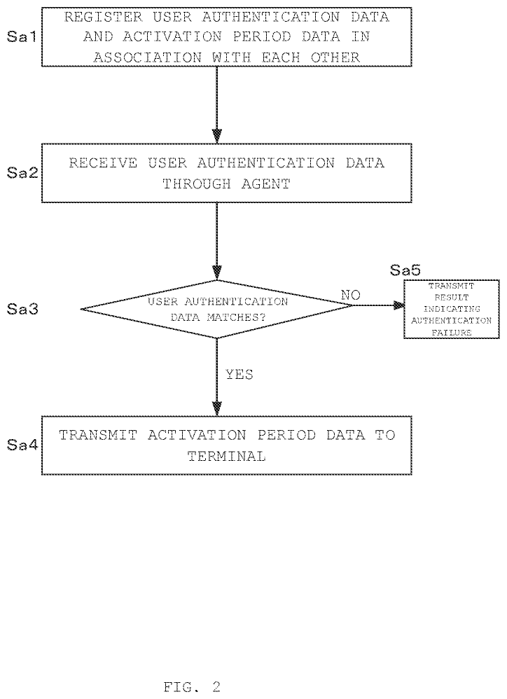

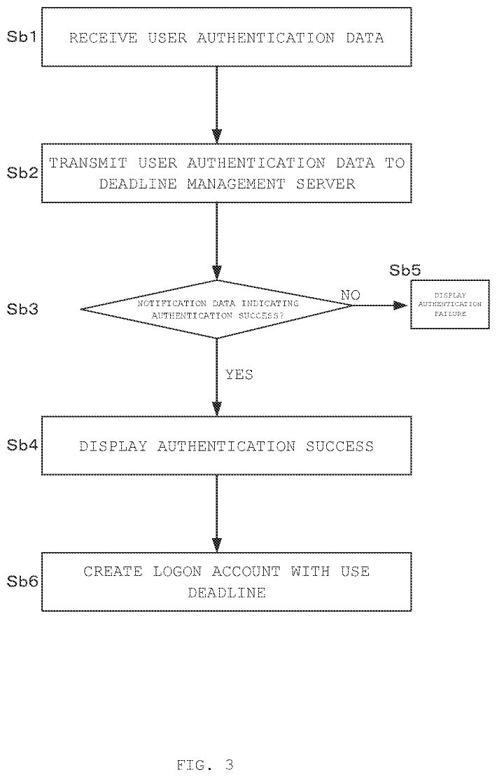

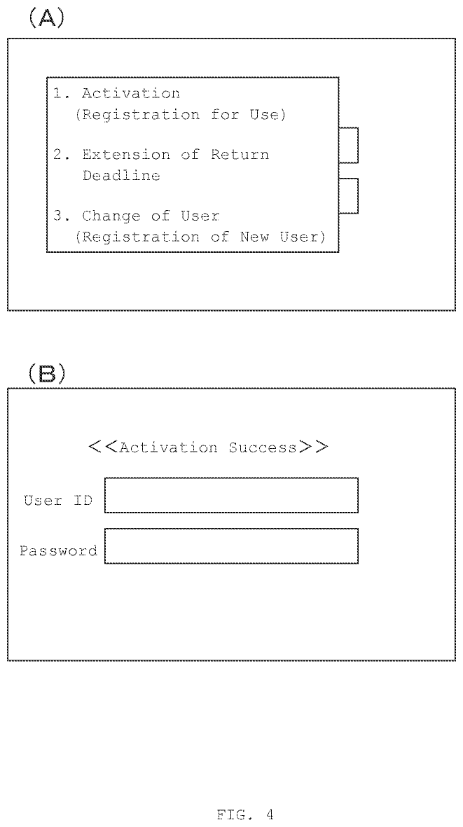

In the following, each phase from renting to return will be described with reference to FIGS. 2 to 4 in relation to an example of the present embodiment. FIG. 2 shows operation steps of the deadline management server, FIG. 3 shows operation steps of the agent program executed by the terminal, and FIGS. 4(A) and 4(B) show examples of screen display displayed on a screen of the terminal by the agent program.

### 1. Advance Registration Phase and Reservation for Renting

A user performs advance registration before renting. In a procedure for advance registration, an authentication card with which the user can be authenticated (a student ID card or a card enabling authentication of an individual may be used) and user identification information are recorded in association with each other. The authentication card is an IC card, for example, and includes information for specifying an individual (such as name, date of birth, student number and the like).

At the time of reservation for renting, advance registration data, user authentication data, and deadline data are recorded in association with one another. The user authentication data includes a name and the like of a user who is registered in advance, a logon ID and a password or, instead thereof, data for identifying an individual (such as biometric information of the user), and the like. Additional pieces of information (such as mobile phone number, email address and the like) may also be included for multi-factor authentication or the like. Moreover, rental period data regarding a terminal is information including numerical values indicating from when to when the terminal can be lent, and is numerical value data including start and end times. Information obtained in this phase is registered in “reservation management server” and “deadline management server”.

The authentication card is read at a counter, the locker or the like and a person who is to receive renting is registered in the reservation management server, and the deadline data indicating a rental period (from when to when renting is performed) is set. The data that is set is shared with the deadline management server. In the case where the deadline management server is to serve the role of the reservation management server, the deadline data that is acquired through the reservation management server is used as it is. In the case where the reservation management server is not used, the deadline data may be input through an office terminal at the counter and be transmitted to the deadline management server. Changes may be made here as appropriate according to design. The deadline management server receives the user authentication data (in this case, information necessary for activation, such as the logon ID and the password) through the agent program (step Sa2).

### 2. Renting of Terminal

When the advance registration phase and reservation for renting are complete, the terminal is lent to the user. Security may be further increased when two-factor authentication is performed by means of transmission of a pin code using contact means (such as transmission of a text message to a mobile phone, transmission to an email address or the like) that is registered in advance before renting. The means of two-factor authentication (or means of multi-factor authentication) is not particularly specified, and multi-factor authentication may be implemented by using a dedicated security device or application software for providing the corresponding function to a smartphone or the like, for example. A rental procedure may be enabled to be swiftly performed by allowing acquisition of the pin code in advance before reception of the terminal. The authentication card (an identification card) is read, a pin code that is obtained in advance is input to a touch panel or the like of a rental locker, a terminal is assigned, a cable is removed, and the terminal is received.

The pin code may be created by the deadline management server, for example. A configuration may be easily achieved according to which the user authentication data held by the deadline management server further includes the mobile phone number or the email address of the user, and the deadline management server creates the pin code and transmits the pin code to the mobile phone number or the email address. The pin code is randomly created from alphabets, numbers and the like, and may be created based on time information, user information or the like. Security may be further increased when the created pin code is transmitted to a smartphone or a mobile phone of the user to be checked against a code that is transmitted to the deadline management server through a device for renting terminals or an office terminal at a counter and a result is returned to the user in the case of match, and the terminal is lent only in the case of successful authentication.

### 3. Start of Use of Terminal

In the case where the terminal is a laptop personal computer or the like, setting is preferably performed such that the screen is locked when the lid is closed and authentication is necessary to release the lock. When more emphasis is put on security, setting may be performed such that shutdown is performed when the lid is closed. Then, the terminal is in a “power-off state (shutdown, suspend, or sleep state)” or in a “logon screen state” or a “lock screen state” immediately after the terminal is lent.

When one tries to use the terminal by turning on the power of the terminal or by opening the lid, the logon screen is displayed. At the same time, in the case of first logon, the agent program is booted, and a dialog screen is displayed. As shown in FIG. 4(A), for example, one of the following items may be selected on the dialog screen:

1. Activation (Registration for Use)

2. Extension of Return Deadline

3. Change of User (Registration of New User).

If activation is already performed, information about the return deadline may be displayed simultaneously with the logon screen. On this screen, the user may “log on by inputting ID/PW on the logon screen” or “select one of the items on an agent screen”.

Additionally, in this phase, there is (normally) no account for the user in the terminal, and logon cannot be performed and the terminal cannot be used yet. Accordingly, normally, an activation operation has to be performed in a network environment (before logon). Additionally, the “network environment” here refers to an environment where the terminal and the deadline management server can be connected over a network, and is possibly only within the LAN. In the case where the terminal is to access the terminal management server from outside the LAN by being carried outside the LAN, a network environment such as the Internet becomes necessary.

### 4. Activation and Separation of User Environment

When activation is selected, a screen for inputting ID/PW of the user is displayed. The agent checks the set of ID/PW that is input with the deadline management server through the network. Specifically, the agent receives the ID/PW through the terminal, and transmits the same to the deadline management server (step Sb2). The deadline management server receives the user authentication data (step Sa2). Then, the deadline management server determines whether the set of ID and PW matches the set of ID and PW input at the time of activation when the terminal was lent, or in other words, whether the user authentication data matches the one acquired at the time of advance registration, and determines whether the user is a legitimate user (step Sa3). At this time, two-factor authentication may be performed again by transmitting a pin code to the mobile phone using a text message. The deadline management server creates a pin code when input of ID/PW is received and transmits the pin code to the user by means of a text message or the like, and the user receiving the pin code inputs the pin code to the terminal by the agent program that is executed by the terminal, and the agent transmits the same to the deadline management server. Two-factor authentication is optional, but in either case, when the user is successfully authenticated by the deadline management server, the server transmits activation period data to the agent (step Sa4). The activation period data includes deadline data associated with the user authentication data, and particularly, “information about the return deadline”. The agent stays in standby to determine whether the activation period data can be received within a predetermined period of time (step Sb3). In the case of authentication failure or in the case where a notification is not received within the predetermined period of time, the deadline management server transmits activation prohibition data indicating authentication failure (step Sa5). When the activation prohibition data is received, the agent performs display to the effect (step Sb5).

When the agent receives the activation period data, authentication success is displayed as shown in FIG. 4(B) (step Sb4), and also, the agent creates a user account with non-administrator authority in a so-called local environment inside the terminal and displays the logon screen (step Sb6). At this time, setting may be performed such that logon can be performed using the ID/PW used at the time of activation. This allows the user to perform logon without getting a strange feeling. It is of course possible to use a new password, and the new password may be set after logon is performed at the time of initial logon using the ID/PW used at the time of activation. Furthermore, because the ID/PW of the user created in the terminal belong to the user himself/herself of the terminal, other users cannot logon in the same environment and there is no possibility of data leakage. In this manner, by allowing logon by creating a different user account for each user, user environments can be separated using a security mechanism of the OS, and thus, data created by a specific user may be prevented from being leaked to other users even in an environment where the terminal is shared.

Furthermore, as described above, in the case where the terminal is a laptop personal computer, lock is preferably applied when a lid of a main body is closed, and in this case, the lock is released by the ID/PW of the user himself/herself. According to such a configuration, the possibility of leakage of data of each user from a terminal for renting may be further reduced. Furthermore, normally, the terminal is returned with the lid of the main body closed. In this case, even if the terminal is lent to the next user without any restoration process and the like, the new user logs onto the terminal as a separate user, and data of the previous user is not leaked.

In this case, “restoration process of the terminal” is a process of restoring the terminal to a state before renting, by using a backup of a hard disk image of the terminal. Additionally, the restoration process and the like of the terminal include not only restoration but also processes of further updating the OS, various pieces of software installed in the terminal, configuration of the terminal and the like after restoration is performed. In the long run, the restoration process and the like (the restoration process and the update process) of the terminal are necessary, but in the short run, a restoration task does not have to be performed every time the user changes, and the freedom of operation is greatly increased.

The user account created in the terminal, user data saved by the user during renting of the terminal, and the like are deleted when the restoration process of the terminal is performed. Moreover, in the case where a new user starts use for the first time, a new user account different from that of the previous user is created in the local environment of the terminal. Accordingly, even in the case of successive use by another user with no restoration process, the accounts are different, and the user data of a user is not leaked to other users.

That is, the restoration process does not have to be performed for the sole purpose of preventing leakage of user information. Accordingly, the restoration process may be performed when the terminal is returned and is not scheduled to be used for some time (such as during nighttime). Actual operation is not obstructed even if frequency of the restoration process is reduced to once a day, for example, and successive renting to a plurality of users may be performed in busy time slots without performing the restoration process and the like and reboot.

When the same user borrows the same terminal again after returning the terminal, a record (data) at the time of previous use is possibly retained, and operation can be performed taking such a state as an advantage. For example, when a user comes to borrow the terminal again after returning the terminal, if there is the same terminal as the previous one, this terminal may be preferentially assigned. In this case, if the user wishes, use may be continued from the state of the previous use, but if the user does not wish so, the terminal may of course be used after being initialized.

### 5. Management of Return Deadline by Agent

The agent may urge return by means of “regularly outputting an alarm on the screen being used” or “displaying a countdown to the return deadline”, for example, when the return deadline approaches based on the “information about the return deadline” acquired from the deadline management server at the time of activation. Furthermore, continuous use ignoring the deadline may be prevented after the deadline by placing the terminal substantially in an unusable state by means of “forcible locking”, “prohibition of new logon” or the like.

Furthermore, the agent may receive an “application for extension of use”. That the terminal can communicate with the deadline management server and the reservation management server is checked, and information such as a use state and a future reservation state of terminals is obtained from the server to check available terminals. When it is determined that other users and operation are not affected even if the return deadline is extended, extension of use of the terminal is applied for, and at the same time, information about the return deadline on the terminal side is updated.

In this case, an additional fee may be charged for the extension of use.

However, in a situation where the number of remaining terminals is small or there is a reservation to use a large number of terminals in a subsequent time slot, the application for extension is rejected. A determination criterion may be set as appropriate according to operation. In this case, the return deadline is not updated, and the user has to temporarily return the terminal.

According to the configuration as described above, in the case where operation is not affected, the user is possibly allowed to extend use without returning the terminal, and convenience is increased.

Furthermore, a configuration may be adopted according to which whether the agent is connected to the network is checked, and in the case where there is a connection, communication is performed with the server on a regular basis to check whether the return deadline is reduced or not. Although limited to a case where the terminal can communicate with the server, such a configuration may enable the return deadline to be reduced for the convenience of the administrator, and this is convenient when the administrator wants the terminal to be returned swiftly for some reason. For this usage, a notification may be transmitted by a text message to the mobile phone that is registered by the user.

Additionally, if extension of the return deadline can be applied for also on the lock screen/logon screen, a user who cannot log on due to expiry of the return deadline may be enabled to log on by applying for extension. Furthermore, a configuration is also possible where, even if the terminal is in a state where communication with the server is not possible, extension may be applied for using a smartphone or the like. However, also in this case, the return deadline is not extended unless the terminal is taken to a place where there is a network connection and re-authentication (extension of the return deadline) is performed by connecting again to the server. Accordingly, when extension of use is accepted through a smartphone, a “coupon for extension of 1 hour” may be displayed, for example. The user may extend use even when the terminal is in an offline state, by inputting the coupon to an extension application screen on the terminal, and convenience of the user is further increased.

### 6. Prohibition and Permission of Re-Renting

Normally, a terminal that is lent to a user is assumed to be used only by the user, and changing the user (that is, “re-renting” to another user) is not desirable even before the return deadline, from the standpoint of managing the terminals. When the present embodiment is applied, the terminal is lent to a specific user, and re-renting is virtually difficult, and appropriate operation is thus enabled.

By contrast, when the administrator determines that no problem arises in relation to management and operation even if change of user is permitted, such as in the case where there is a sufficient number of remaining terminals or in the case where there are not many reservations for use of the terminals, change of the user may be permitted by notifying the server of change of the user through the agent.

When the user applies to the agent for start of a procedure for changing the user, the agent urges input of ID/PW and the like of “user after change”, and performs authentication of the user after change. Then, communication with the server is performed, and the procedure for changing the user is continued. The server determines whether the user can be changed or not by checking the use state and the reservation state of terminals, and issues a notification to the agent. When acceptance is obtained, the agent creates an account for the new user in the terminal, and updates setting such as the information regarding the return deadline. To increase security, authentication may be performed in relation not only to the “user after change” but also to a “current user”.

A flow of changing the user simply includes advance registration of the user after change by the deadline management server and performance of activation (registration for use) in relation to the user after change, and a basic flow is as described above. However, it is further possible to make clear which user is a responsible person renting the terminal by disabling logon by the original user after change of the user. Additionally, even if activation of the terminal that is being lent is performed simultaneously for a plurality of users, accounts being used on the terminal are different, and user data is not leaked.

### 7. Return of Terminal

At the time of return of the terminal, the terminal is brought to a predetermined return location (in the case of automatic management, a rental locker is assumed; in the case of manual management, a counter is assumed). In the case where return is completed before the return deadline, completion of return of the terminal is registered in the deadline management server 50 to thereby prevent transmission of a message for stopping notification of arrival of the deadline.

In the case where the terminal is a laptop personal computer, the lid of the main body is normally closed at the time of return of the terminal. Accordingly, in the case of a configuration according to which lock is applied when the lid of the main body is closed, leakage of user data may be naturally prevented.

### 8. Rare Case

In the case where a user possesses a terminal without performing activation after renting the terminal, a case is conceivable where the user is at a loss, not knowing how to perform activation. In such a case, the deadline management server may provide attentive support by performing follow-up of, for example, transmitting a text message to the mobile phone of the user after a lapse of a certain period of time.

As described above, with the system of the embodiment, an account is created in a local environment, and even when the system lets an unspecified large number of users use a terminal, leakage of information of a previous user may be prevented. Furthermore, although it is premised that the terminal itself is used in a “local environment (non-domain environment)” at the time of logon without needing a network environment, a mechanism that can cope with requests on a per-user basis may be adopted by managing, after renting, the use deadline by the deadline management server that is provided outside, and attentive services may be provided to each user.

Furthermore, when the renting deadline arrives, connection may be made to the deadline management server through a network to update (extend) the return deadline in response to a justifiable request from the user to appropriately extend the return deadline, without the need to perform the renting procedure again by taking the terminal to the return location.

### -Modification-

Additionally, in the example described above, the deadline management server is configured such that the deadline data is held in association with the user authentication data, user authentication is always performed at the time of terminal activation, and an account is created in the local environment of the terminal only in the case of successful user authentication. However, in a more simplified example, user authentication may be made unnecessary by using a configuration where logon is performed using a default account (a guest account). In this case, the activation period data may include only the deadline data, without including the user authentication data. This case allows extension of the return deadline by the same user, but is not suitable in the case of changing the user because data saved in local folders for all the users can be browsed.

### (Second Embodiment)—More Refined Embodiment—

The first embodiment described above is designed such that activation (registration for use) is necessary immediately after the terminal is lent. Accordingly, although there is no difference to the fact that “a terminal for renting is expected to be used offline (in a state where there is no network connection)”, an operational restriction that “a terminal has to be used in a place where there is a network connection at the time of initial activation immediately after the terminal is lent” is imposed.

However, with the premise of the locker including the terminal locker control unit described in the first embodiment, and by indirectly transferring the activation period data using “a smartphone or another personal device of the user connected to a network” and “coded activation period data”, activation can be performed even when the terminal and the deadline management server are not directly connected to the network, and thus, restrictions on the user may be further reduced and convenience may be further increased.

Specifically, first, a coded image indicating data including unique terminal information and the URL of a web server is displayed on the screen of the terminal by the agent program that is executed on the terminal. Next, when the displayed image is read by the personal device of the user, the user is enabled to access the web server through the personal device. Next, the deadline management server is allowed to acquire the unique terminal information through the web server, and whether information about the user that is estimated based on information obtained from the personal device and user information that is estimated by referring to a rental record or the like from the unique terminal information match is checked. At this time, additional authentication may be demanded by, for example, making the user further input a user ID and a password through the web server, and the user authentication data that is held by the deadline management server and that is used by the user using the terminal to log onto the terminal may be checked against the user authentication data that is acquired through the web server. The activation period data may be created together with notification data indicating a result indicating successful user authentication that is obtained as a result of above-described determination of success/failure of user authentication and the activation period data may be allowed to be coded and transmitted to the personal device, and the terminal may be made to read a coded image that indicates the activation period data and that is displayed on the personal device, and the coded activation period data may be decoded. At this time, information about the user authentication data may be further included in the activation period data.

Additionally, the web server may be constructed on the deadline management server, or may be constructed on a server other than the deadline management server.

### -Example-

A description will be given of activation that uses a QR code (registered trademark) as an example.

When the rental locker is used, the terminal that is lent and the user are identified at the time point of the user taking out the terminal from the locker. Accordingly, data necessary for user authentication may be transmitted from the terminal locker control unit to the deadline management server at the time when the terminal is lent. On the other hand, the user has to perform terminal activation to place the terminal in a usable state. The unique terminal information and a URL for inputting the user authentication data for logon to the terminal are displayed on the screen of the terminal by means of the QR code (registered trademark), by the agent program that is executed on the terminal.

When the user captures the QR code (registered trademark) with a camera of the personal device (a smartphone, a tablet or the like) in this state and activates a browser, the URL for inputting the user authentication data is accessed. Then, the user is made to input authentication information (a set of logon ID and password, or the like) for the terminal notified at the time of reservation for the terminal. A configuration is also possible where unique information of the personal device is used instead of the logon ID and the password. For the deadline management server, the authentication information acquired in this phase is a “request for terminal activation”. The deadline management server determines whether the authentication information is correct by checking the authentication information of the terminal that is input against the authentication information that is received in advance from the locker control unit. In the case where “correct” is determined, the activation period data including the deadline data and the notification data indicating a result indicating successful user authentication is coded into the format of a QR code (registered trademark) and is transmitted to the personal device of the user by means of an email, a text message or the like. As described above, a general QR code (registered trademark) can hold text data of about 2000 bits, and thus, it is possible to code the activation period data itself into the format of the QR code (registered trademark).

The user who received the notification is enabled to display the QR code (registered trademark) on the personal device. The terminal may acquire the deadline data and the user authentication data by reading the QR code (registered trademark) with the camera of the terminal and by decoding the same on the terminal. Then, based on the activation period data after decoding, the agent program executed on the terminal changes setting information of the terminal and creates a local account, and the terminal is enabled to be used until the return deadline specified by the user at the time of renting.

As described above, according to the second embodiment, activation of the terminal can be performed even when the terminal and the deadline management server are not directly connected through a network.

### REFERENCE SIGNS LIST

FIG. 1
20 TERMINAL LOCKER
21 TERMINAL STORAGE UNIT
22 TERMINAL MANAGEMENT BOX
28 TERMINAL LOCKER CONTROL UNIT
50 DEADLINE MANAGEMENT SERVER
FIG. 2
Sa1 REGISTER USER AUTHENTICATION DATA AND ACTIVATION PERIOD DATA IN ASSOCIATION WITH EACH OTHER
Sa2 RECEIVE USER AUTHENTICATION DATA THROUGH AGENT
Sa3 USER AUTHENTICATION DATA MATCHES?
Sa4 TRANSMIT ACTIVATION PERIOD DATA TO TERMINAL
Sa5 TRANSMIT RESULT INDICATING AUTHENTICATION FAILURE
#1 YES
#2 NO
FIG. 3
Sb1 RECEIVE USER AUTHENTICATION DATA
Sb2 TRANSMIT USER AUTHENTICATION DATA TO DEADLINE
MANAGEMENT SERVER
Sb3 NOTIFICATION DATA INDICATING AUTHENTICATION SUCCESS?
Sb4 DISPLAY AUTHENTICATION SUCCESS
Sb5 DISPLAY AUTHENTICATION FAILURE
Sb6 CREATE LOGON ACCOUNT WITH USE DEADLINE
#1 YES
#2 NO
FIG. 4(A)
#1 1. Activation (Registration for Use)
#2 2. Extension of Return Deadline
#3 3. Change of User (Registration of New User)
FIG. 4(B)
#1 Activation Success
#2 User ID
#3 Password

1. A deadline management server for managing a return deadline for a terminal for rental, wherein,
in response to a request for terminal activation issued to the deadline management server by an agent program executed on the terminal, the deadline management server
issues, to a user of the terminal, activation period data including deadline data regarding the return deadline for the terminal, the deadline data being set in advance by the deadline management server, and
causes the agent program to change a setting of the terminal.

2. The deadline management server according to claim 1, wherein the request is issued by the agent program.

3. The deadline management server according to claim 1, wherein the request includes unique terminal information for identifying the terminal.

4. The deadline management server according to claim 1, wherein, after issuing the activation period data, the deadline management server transmits the activation period data to be received by the agent program, through a network or a recording medium.

5. The deadline management server according to claim 4, wherein, after issuing the activation period data, the deadline management server issues and transmits a code indicating the activation period data or information associated with the activation period data, such that the transmitting of the activation period data to be received by the agent program is indirect transmission through the code.

6. The deadline management server according to claim 5, wherein the deadline management server includes a function of transmitting the code to a personal device of the user.

7. The deadline management server according to claim 6, wherein,
in a case of success of a user authentication by a user authentication server for receiving user authentication data input to the terminal through the agent program and for determining a success/failure of the user authentication,
the deadline management server notifies the terminal of the success/failure of the user authentication by receiving the success/failure of the user authentication and including notification data indicating the user authentication success in the activation period data based on a result of the determination.

8. The deadline management server according to claim 7, wherein the deadline management server also serves as the user authentication server.

9. The deadline management server according to claim 3, wherein,
in a case where the terminal for rental and a user are associated with each other at a time of renting the terminal, by a terminal locker recording a rental record of the terminal, and the unique terminal information is included in the request for the deadline management server,
the deadline management server further includes an additional authentication function of checking whether user information included in the user authentication data matches the user renting the terminal, by checking the unique terminal information included in the request against the rental record at a time of rental of the terminal.

10. The deadline management server according to claim 7, wherein the authentication server
includes a mechanism for authenticating the user through the personal device of the user, and
determines the success/failure of the user authentication when the request for terminal activation of the terminal is notified to the user authentication server through the personal device of the user,
the activation period data further includes notification data indicating the success of the user authentication, and
a configuration for coding and transmitting the activation period data to the personal device is included.

11. The deadline management server according to claim 7, further comprising a function of the user authentication server including a mechanism for authenticating a user by causing a code including the unique terminal information and an URL of the user authentication server displayed on a screen of the terminal by the agent program to be read through the personal device; and causing a user name and a password to be input at a destination indicated by the URL of the user authentication server.

12. The deadline management server according to claim 6, further comprising a function to hold information about the personal device used for processing the request for terminal activation at least until the terminal is returned, and to issue an alarm to the personal device when the return deadline approaches.

13. An agent program to be executed on a terminal for rental, wherein,
initial use of the terminal or uses the terminal beyond a preset return deadline for the terminal,
the agent program directly or indirectly receives activation period data including at least deadline data regarding the preset return deadline for the terminal by a deadline management server, and sets settings information of the terminal according to the deadline data included in the activation period data.

14. The agent program according to claim 13, wherein the activation period data that is coded is read from a personal device of a user through an input device of the terminal.

15. The agent program according to claim 13, wherein, where notification data indicating success of user authentication is included in the activation period data, the agent program changes the setting information of the terminal according to authentication information input through the agent program or authentication information included in the activation period data.

16. The agent program according to any one of claims 13, wherein the agent program includes issuing an alarm to urge the user to perform return, before the return deadline for the terminal.

17. The agent program according to claim 13, further comprising a function of transmitting, to the deadline management server, a request to extend an activation period depending on a rental state of the terminal on a due data of return.

18. The agent program according to claim 13, further comprising a function of making the terminal substantially unusable when a deadline of returning the terminal is missed, by forcing the user to log off or by preventing logon from being performed again by changing the settings information of the terminal.

19. The agent program according to claim 15, wherein a value created based on unique terminal information for identifying the terminal is used as a key at a time of encrypting the notification data.

20. A terminal lending system comprising the deadline management server according to claim 1, and a terminal,
wherein the terminal is configured to execute an agent program, and
wherein when a user begins initial use of the terminal or uses the terminal beyond a preset return deadline for the terminal, the agent program directly or indirectly receives activation period data including at least deadline data regarding the return deadlin for the terminal set in advance by a deadline management server, and sets settings information of the terminal according to the deadline data included in the activation period data.

21. A deadline management server for managing a return deadline for a terminal for renting, wherein,
in response to a request for terminal activation issued to the deadline management server by an agent program executed on the terminal, the deadline management server
issues, to a user of the terminal, activation period data including deadline data regarding the return deadline for the terminal, the deadline data being set in advance by the deadline management server, and
causes the agent program to change a setting of the terminal, and
allows a change of the user by notifying the change of the user to the server through the agent.

22. A deadline management server for managing a return deadline for a terminal for renting, wherein,
in response to a request for terminal activation issued to the deadline management server by an agent program executed on the terminal, the deadline management server
issues, to a user of the terminal, activation period data including deadline data regarding the return deadline for the terminal, the deadline data being set in advance by the deadline management server, and
causes the agent program to change a setting of the terminal, and
issues a notification urging the user to activate the terminal, in a case where the terminal activation is not performed for a certain period of time after the request is issued by the deadline management server.

23. A deadline management server for managing a return deadline for a terminal for renting, wherein,
in response to a request for terminal activation issued to the deadline management server by an agent program executed on the terminal, the deadline management server
issues, to a user of the terminal, activation period data including deadline data regarding the return deadline for the terminal, the deadline data being set in advance by the deadline management server, and
causes the agent program to change a setting of the terminal, and
to acquire the deadline data, receives from an office terminal used for management of renting the terminal, at a time of renting the terminal to the user, authentication information for identifying the user, information about the terminal to be rented to the user and deadline data including the return deadline that are input to the office terminal.

24. A deadline management server for managing a return deadline for a terminal for renting, wherein,
in response to a request for terminal activation issued to the deadline management server by an agent program executed on the terminal, the deadline management server
issues, to a user of the terminal, activation period data including deadline data regarding the return deadline for the terminal, the deadline data being set in advance by the deadline management server, and
causes the agent program to change a setting of the terminal, and
allows, in a case where the user is to use the terminal again after returning the terminal, selection of whether to rent the terminal such that data of the user at a time of previous use is restored.

25. An agent program to be executed on a terminal for renting, wherein,
when a second user starts use of the terminal, the second user different from a first user using the terminal,
the agent program notifies a deadline management server of a change from the first user to the second user, and
the agent program directly or indirectly receives activation period data including deadline data regarding at least a return deadline for the terminal, the deadline data being newly set by the deadline management server for the second user, and changes settings information of the terminal according to the deadline data included in the activation period data.
